(19) United States
(12) Patent Application Publication
(10) Pub. No.: US 2026/0166717 A1
(43) Pub. Date: Jun. 18, 2026

(54) ITEM TRANSPORT DEVICE AND ITEM TRANSPORT METHOD

(71) Applicant: Honda Motor Co., Ltd., Tokyo (JP)

(72) Inventors: Taisei WAKISAKA, Tokyo (JP); Masao SHIMOYAMA, Tokyo (JP); Yasushi IWATANI, Tokyo (JP); Tetsuro YAMANOBE, Tokyo (JP)

(73) Assignee: Honda Motor Co., Ltd., Tokyo (JP)

(21) Appl. No.: 19/287,847

(22) Filed: Aug. 1, 2025

(30) Foreign Application Priority Data
Dec. 17, 2024 (CN) 202411858674.5

(51) Int. Cl. B25J 9/00; B23P 19/10

(52) U.S. Cl. CPC B25J 9/0096; B23P 19/10; B25J 9/0084

(57) ABSTRACT

An item transport device and item transport method that may improve item transport efficiency through simple component composition and have versatility. The item transport device includes a jig and first and second robot arms. First robot arm has a first universal holding part conforming shape of the item through abutting a shape transfer mold and maintains the conformed shape. Second robot arm has a second universal holding part conforming shape of the item through abutting a shape transfer mold and maintains the conformed shape. The jig has a universal placement part conforming shape of the item through abutting a shape transfer mold and maintains the conformed shape. First robot arm places item on universal placement part of position coordinates that have conformed shape transfer mold on jig, and second robot arm retrieves item from universal placement part on jig. The item transport method transports the item through item transport device.

### CROSS-REFERENCE TO RELATED APPLICATION

This application claims the priority benefit of China application serial no. 202411858674.5, filed on Dec. 17, 2024. The entirety of the above-mentioned patent application is hereby incorporated by reference herein and made a part of this specification.

### BACKGROUND

### Technical Field

The disclosure relates to an item transport device and an item transport method.

### Related Art

In recent years, research and development related to improving energy efficiency that contributes to energy efficiency is being conducted in order to ensure access to more affordable, reliable, sustainable and advanced energy for more people. However, in technology for improving energy efficiency, for example, the transport efficiency of transport devices and transport methods for transporting vehicle body parts to be assembled on production lines is an issue.

In the related art (for example, Japanese Patent Application Laid-Open Publication No. 2009-18769), as a universal jig used when assembling vehicle body parts (for example, roof panels) on a production line for mixed production of multiple vehicle models, a support component with a spherical front end that supports vehicle body parts, a vacuum suction cup that adsorbs and fixes the vehicle body structure, and a control device that uses an electric actuator to move the support component and vacuum suction cup up and down are used, and control is executed to place the vehicle body parts at predetermined positions that are pre-taught to the universal jig. At this time, if the position coordinates of the pre-taught predetermined position and the actual placement position are offset, correction of the offset of the vehicle body parts cannot be performed. Thus, the vehicle body parts need to be correctly placed at the predetermined position of the universal jig. However, in order to correctly place the vehicle body parts at the predetermined position, the universal jig, for example, is provided with through-type jig pins to prevent position offset of the vehicle body parts, and uses a scanner (for example, a camera) to confirm and correct the position coordinates of the vehicle body parts. Thus, universalization of the jig requires additional equipment investment (for example, through-type jig pins and scanners).

The disclosure aims to solve the aforementioned problems by achieving improved item transport efficiency through a simple component configuration. Furthermore, the disclosure contributes to energy efficiency.

### SUMMARY

The disclosure provides an item transport device and an item transport method that may improve item transport efficiency through simple component configuration and have versatility.

The disclosure provides an item transport device, which includes the following. A jig is configured to place an item to be transported. A first robot arm retrieves the item from a storage place and places on the jig. Also, a second robot arm retrieves the item placed on the jig. In an embodiment, the first robot arm has a first universal holding part, the first universal holding part conforms a shape of the item through abutting a shape transfer mold and maintains the conformed shape, in which the shape transfer mold has a shape corresponding to the item. The second robot arm has a second universal holding part, the second universal holding part conforms the shape of the item through abutting the shape transfer mold and maintains the conformed shape. The jig has a universal placement part, the universal placement part conforms the shape of the item through abutting the shape transfer mold and maintains the conformed shape. The first robot arm places the item on the universal placement part of position coordinates that have conformed the shape transfer mold on the jig, and the second robot arm retrieves the item from the universal placement part on the jig.

The disclosure further provides an item transport method transporting an item through an item transport device, and the item transport device includes the following. A jig is configured to place an item to be transported. A first robot arm retrieves the item from a storage place and places on the jig. A second robot arm retrieves the item placed on the jig. Also, a control component controls the actions of the first robot arm and the second robot arm. In the embodiment, the first robot arm has a first universal holding part, the first universal holding part conforms the shape of the item through abutting a shape transfer mold and maintains the conformed shape, in which the shape transfer mold has a shape corresponding to the item. The second robot arm has a second universal holding part, the second universal holding part conforms the shape of the item through abutting the shape transfer mold and maintains the conformed shape. The jig has a universal placement part, the universal placement part conforms the shape of the item through abutting the shape transfer mold and maintains the conformed shape. The item transport method includes controlling the first robot arm and the second robot arm by the control component to perform the following actions. The first robot arm retrieves the shape transfer mold from a mold placement place and places on the jig, the second robot arm retrieves the shape transfer mold from the jig and places at the mold placement place, the first robot arm places the item on the jig based on the position of the universal placement part where the shape transfer mold is placed on the jig, and the second robot arm retrieves the item from the jig based on the position of the universal placement part where the shape transfer mold is retrieved from the jig.

Based on the above, in the item transport device and the item transport method of the disclosure, the first robot arm conforms the shape of the item through the first universal holding part abutting the shape transfer mold corresponding to the shape of the item, the second robot arm conforms the shape of the item through the second universal holding part abutting the shape transfer mold, and the jig conforms the shape of the item through the universal placement part abutting the shape transfer mold. Moreover, the first robot arm places the item on the universal placement part based on the position coordinates that have conformed the shape transfer mold on the jig, and the second robot arm retrieves the item from the universal placement part. In this way, without being limited by the type of the item, the item transport device and the item transport method may conform the shape of the item through the universal equipment such as the first robot arm, the second robot arm, and the jig in combination with the shape transfer mold corresponding to the shape of the item, thereby enabling positioning to the required degree for transport and transporting the item with a simplified structure such as transport of the shape transfer mold without requiring precise positioning means (for example, omitting positioning means or detection means in the related art). Accordingly, the item transport device and the item transport method of the disclosure may improve item transport efficiency through simple component composition and have versatility.

To make the foregoing features and advantages of the disclosure more comprehensible, embodiments are specifically provided below and described in detail with accompanying drawings as follows.

### BRIEF DESCRIPTION OF THE DRAWINGS

FIG. 1 is a schematic diagram of a configuration structure of an item transport device according to an embodiment of the disclosure.

FIG. 2 is a schematic diagram of an electrical structure of the item transport device shown in FIG. 1.

FIG. 3 is a partial enlarged schematic diagram of a first robot arm used in the item transport device shown in FIG. 1.

FIG. 4 is a partial enlarged schematic diagram of a second robot arm used in the item transport device shown in FIG. 1.

FIG. 5A to FIG. 5C are schematic diagrams of a process of a jig used in the item transport device shown in FIG. 1 when transporting an item.

FIG. 6 is a timing schematic diagram of a process of the item transport device shown in FIG. 1 when transporting the item.

FIG. 7 is a timing schematic diagram of a process of the item transport device shown in FIG. 1 when transporting the item multiple times.

FIG. 8 is a timing schematic diagram of a process of the item transport device shown in FIG. 1 when transporting multiple items of different types multiple times.

FIG. 9 is a side view schematic diagram of a shape transfer mold used in the item transport device shown in FIG. 1.

FIG. 10 is a flowchart of an item transport method according to an embodiment of the disclosure.

### DESCRIPTION OF THE EMBODIMENTS

In an embodiment according to the disclosure, the item transport device further includes the following. A control component controls the actions of the first robot arm and the second robot arm, in which the control component controls the first robot arm and the second robot arm to perform the following actions. The first robot arm retrieves the shape transfer mold from the mold placement place and places on the jig, and the second robot arm retrieves the shape transfer mold from the jig and places at the mold placement place.

In an embodiment according to the disclosure, the control component controls the first robot arm and the second robot arm to perform the following actions. The first robot arm places the item on the jig based on the position of the universal placement part where the shape transfer mold is placed on the jig, and the second robot arm retrieves the item from the jig based on the position of the universal placement part where the shape transfer mold is retrieved from the jig.

In an embodiment according to the disclosure, the item includes multiple items of different types that constitute one finished product, the shape transfer mold includes multiple shape transfer molds respectively corresponding to the items of different types, and the first robot arm and the second robot arm sequentially transport the items of different types for the finished product.

In an embodiment according to the disclosure, the item transport device further includes the following. A control component controls the actions of the first robot arm and the second robot arm, in which the items include at least a first item and a second item that are of different types and constitute one finished product, the shape transfer molds include at least a first shape transfer mold corresponding to the first item and a second shape transfer mold corresponding to the second item, and the control component controls the first robot arm and the second robot arm to perform the following actions. The first robot arm retrieves the first shape transfer mold from the mold placement place and places on the jig, the second robot arm retrieves the first item from the jig, the first robot arm retrieves the second shape transfer mold from the mold placement place and places on the jig, and the second robot arm retrieves the second item from the jig.

In an embodiment according to the disclosure, the control component controls the first robot arm and the second robot arm to perform the following actions. In a process of the second robot arm retrieving the first item from the jig, the first robot arm retrieves the second shape transfer mold from the mold placement place and places on the jig.

In an embodiment according to the disclosure, the control component performs a Nth cycle of transporting a set of the first item and the second item corresponding to one finished product, and after completing the Nth cycle, perform a (N+1)th cycle of transporting a next set of the first item and the second item corresponding to a next finished product, where N is a natural number greater than 0.

In an embodiment according to the disclosure, the control component controls the first robot arm and the second robot arm to perform the following actions. In a process of the second robot arm retrieving the second item from the jig in the Nth cycle, the first robot arm retrieves the first shape transfer mold from the mold placement place and places on the jig in the (N+1)th cycle.

In an embodiment according to the disclosure, the item transport device further includes the following. A scanning component is disposed on at least one of the first robot arm and the second robot arm, and configured to detect the shape of the item or the shape transfer mold.

In an embodiment according to the disclosure, the item transport device further includes the following. A scanning component is disposed on the jig, and configured to detect the shape of the universal placement part.

In an embodiment according to the disclosure, the shape transfer mold includes a surface transfer face corresponding to the surface of the item and an inner transfer surface corresponding to the inner side of the item, and is integrally formed with a thick section of a preset thickness between the surface transfer face and the inner transfer surface.

In an embodiment according to the disclosure, the item transport device further includes the following. A scanning component is disposed on at least one of the first robot arm and the second robot arm, and configured to detect the shape of the item or the shape transfer mold, and the scanning component performs the following actions. When the first robot arm retrieves the shape transfer mold from the mold placement place and places on the jig, the scanning component scans the shape transfer mold and sends position coordinates to the control component, when the second robot arm retrieves the shape transfer mold from the jig and places at the mold placement place, the scanning component scans the shape transfer mold and sends position coordinates to the control component, when the first robot arm places the item on the jig based on the position of the universal placement part where the shape transfer mold is placed on the jig, the scanning component scans the item when the first robot arm retrieves the item from the storage place and sends position coordinates to the control component, and when the second robot arm retrieves the item from the jig based on the position of the universal placement part where the shape transfer mold is retrieved from the jig, while transporting the item on the jig, the scanning component does not perform scanning on the item.

In an embodiment according to the disclosure, the scanning component performs the following action. When the first robot arm places the item on the jig based on the position of the universal placement part where the shape transfer mold is placed on the jig, the scanning component does not perform scanning on the item when the first robot arm retrieves the item from the storage place.

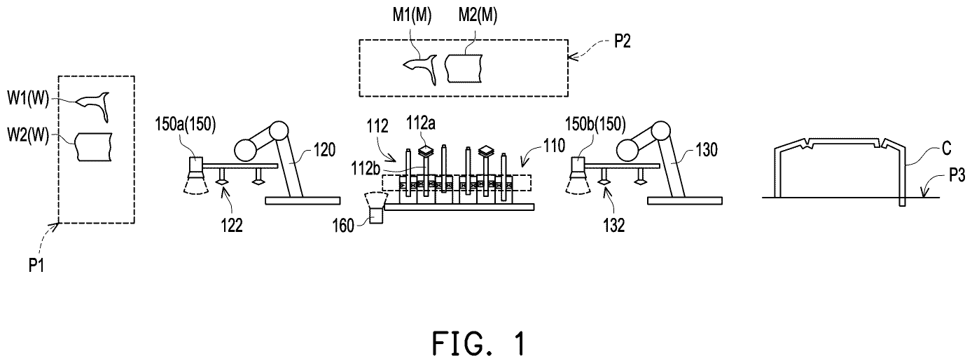

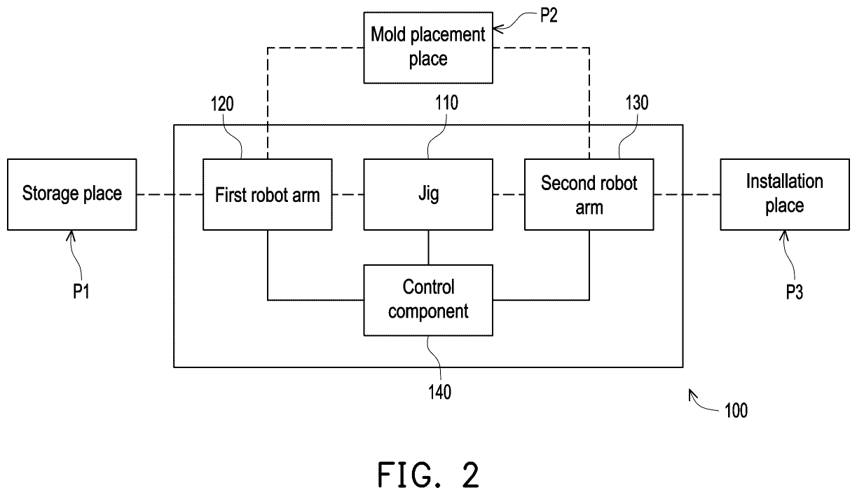

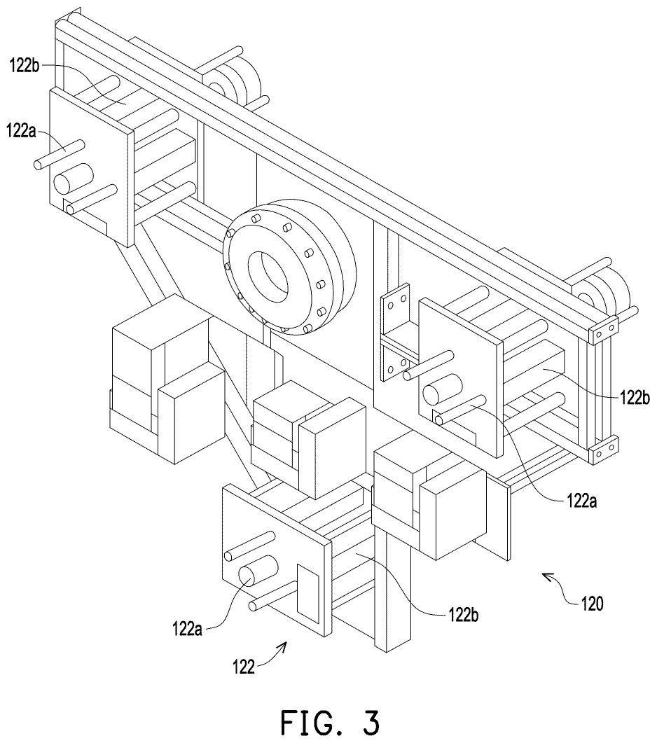

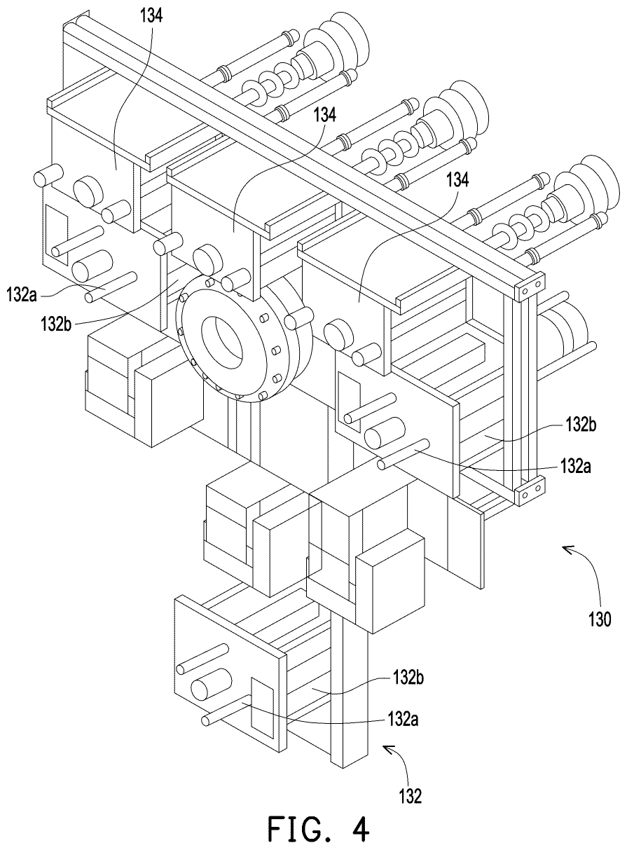

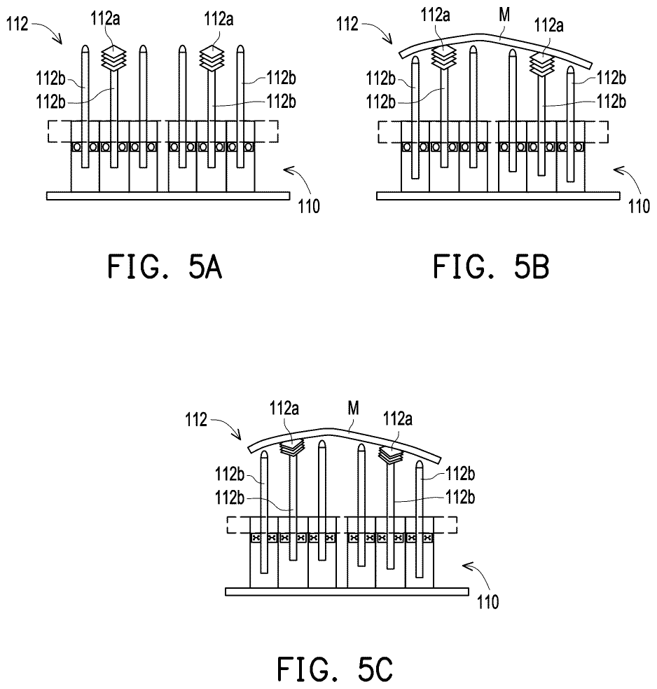

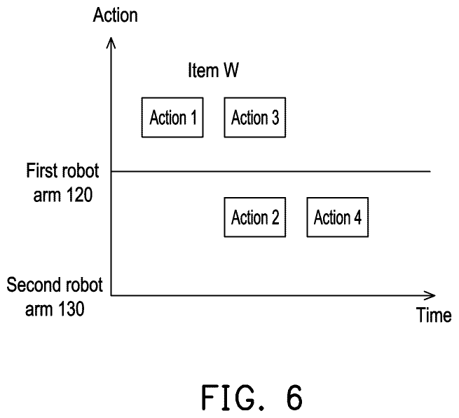

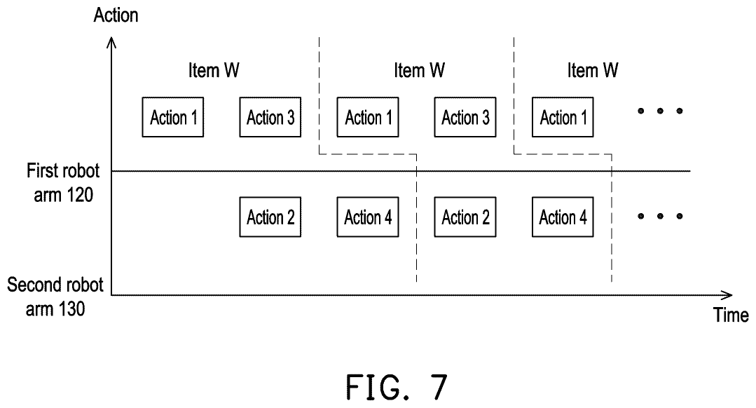

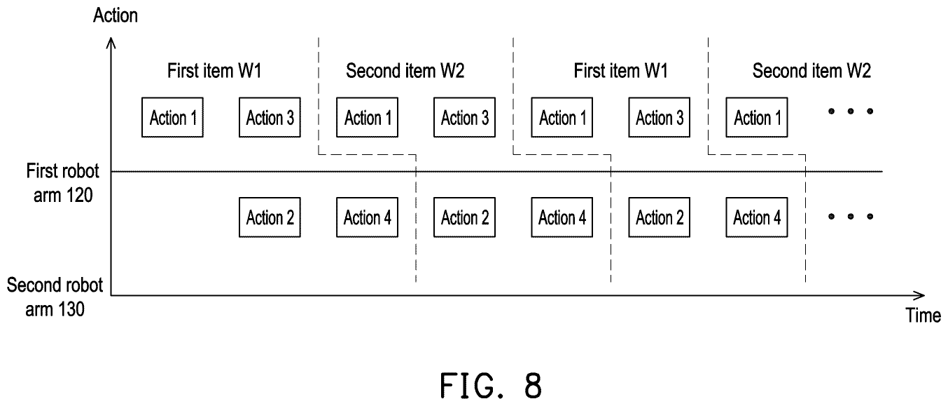

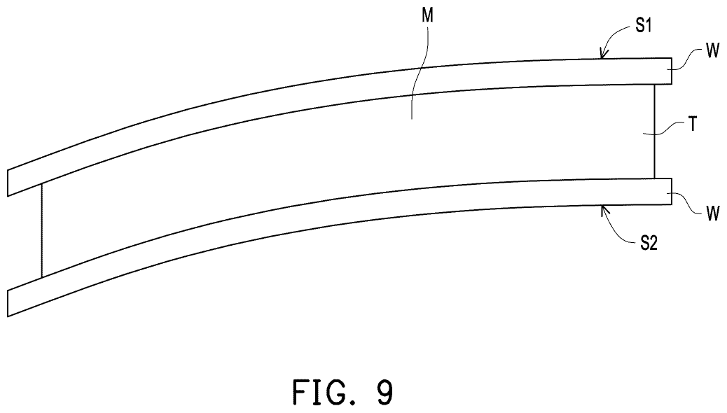

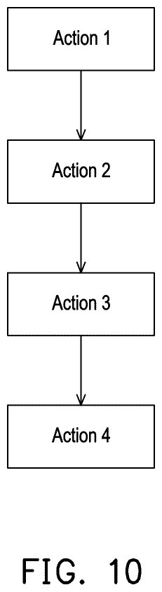

Reference will now be made in detail to exemplary embodiments of the disclosure, examples of the exemplary embodiments are illustrated in the accompanying drawings. Among the drawings, FIG. 1 is a schematic diagram of a configuration structure of an item transport device according to an embodiment of the disclosure, FIG. 2 is a schematic diagram of an electrical structure of the item transport device shown in FIG. 1, FIG. 3 is a partial enlarged schematic diagram of a first robot arm used in the item transport device shown in FIG. 1, FIG. 4 is a partial enlarged schematic diagram of a second robot arm used in the item transport device shown in FIG. 1, FIG. 5A to FIG. 5C are schematic diagrams of a process of a jig used in the item transport device shown in FIG. 1 when transporting an item, FIG. 6 is a timing schematic diagram of a process of the item transport device shown in FIG. 1 when transporting the item, FIG. 7 is a timing schematic diagram of a process of the item transport device shown in FIG. 1 when transporting the item multiple times, FIG. 8 is a timing schematic diagram of a process of the item transport device shown in FIG. 1 when transporting multiple items of different types multiple times, FIG. 9 is a side view schematic diagram of a shape transfer mold used in the item transport device shown in FIG. 1, FIG. 10 is a flowchart of an item transport method according to an embodiment of the disclosure. The following will use FIG. 1 to FIG. 10 to illustrate the specific structure of an item transport device 100 of this embodiment and the operation flow of the item transport method, but this is merely one example, and the disclosure is not limited thereto and may be adjusted according to requirements.

Referring to FIG. 1 and FIG. 2, in this embodiment, the item transport device 100 includes a jig 110, a first robot arm 120, and a second robot arm 130. The jig 110 is configured to place an item W to be transported (for example, vehicle body parts such as fenders, front vehicle doors, or rear vehicle doors used for being assembled into a vehicle body structure, but the disclosure is not limited thereto). The first robot arm 120 retrieves the item W from a storage place P1 and places on the jig 110. The second robot arm 130 retrieves the item W placed on the jig 110. The first robot arm 120 has a first universal holding part 122, and the first universal holding part 122 conforms a shape of the item W through abutting a shape transfer mold M and maintains the conformed shape, in which the shape transfer mold M has a shape corresponding to the item W. The second robot arm 130 has a second universal holding part 132, and the second universal holding part 132 conforms the shape of the item W through abutting the shape transfer mold M and maintains the conformed shape. The jig 110 has a universal placement part 112, and the universal placement part 112 conforms the shape of the item W through abutting the shape transfer mold M and maintains the conformed shape. Furthermore, the first robot arm 120 places the item W on the universal placement part 112 of position coordinates that have conformed the shape transfer mold M on the jig 110, and the second robot arm 130 retrieves the item W from the universal placement part 112 on the jig 110.

Specifically, in the present embodiment, as shown in FIG. 1 and FIG. 2, the front end (moving end) of the first robot arm 120 disposed with the first universal holding part 122 may move between a mold placement place P2 and the jig 110, and retrieve the shape transfer mold M from the mold placement place P2 and place on the jig 110, and may move between the storage place P1 and the jig 110, and retrieve the item W from the storage place P1 and place on the jig 110. That is, the first robot arm 120 is a placement robot arm configured to place the item W or the shape transfer mold M on the jig 110. Thus, the first robot arm 120 may perform the action of placing the shape transfer mold M on the jig 110 and the action of placing the item W on the jig 110. In contrast, the front end (moving end) of the second robot arm 130 disposed with the second universal holding part 132 may move between the jig 110 and the mold placement place P2, and retrieve the shape transfer mold M from the jig 110 and place at the mold placement place P2, and may move between the jig 110 and the installation place P3, and retrieve the item W from the jig 110 for assembly at the installation place P3. That is, the second robot arm 130 is a retrieving robot arm configured to retrieve the item W or the shape transfer mold M from the jig 110. Thus, the second robot arm 130 may perform the action of retrieving the shape transfer mold M from the jig 110 and the action of retrieving the item W from the jig 110.

Furthermore, in the present embodiment, as shown in FIG. 3, the first universal holding part 122 of the first robot arm 120 includes multiple first adsorption components 122a (for example, three) formed by suction cups and a vacuum source (not shown), and multiple first drive pins 122b that are movable. In the situation where the front end (moving end) of the first robot arm 120 disposed with the first universal holding part 122 moves to the mold placement place P2, the first universal holding part 122 abuts the shape transfer mold M through the first drive pins 122b to conform the shape of the shape transfer mold M (corresponding to the shape of the item W) and maintains the conformed shape (for example, locking the first drive pins 122b), and holds (adsorbs and fixes) the shape transfer mold M through the first adsorption components 122a. Here, the conformation of the shape of the shape transfer mold M refers to making the front ends of the first drive pins 122b abut the surface of the shape transfer mold M respectively through the movement of the movable first universal holding part or the first robot arm 120, and making the first drive pins 122b move through abutting the surface of the shape transfer mold M. Furthermore, the maintaining of the conformed shape refers to locking the first drive pins 122b that move through abutting the surface of the shape transfer mold M to fix current positions of the first drive pins 122b, positioning the first drive pins 122b at positions abutting the shape transfer mold M without moving due to abutting the shape transfer mold M. Thereafter, the first robot arm 120 places the shape transfer mold M that is held on the jig 110 through movement, and the first robot arm 120 releases the holding (releases adsorption), thereby completing the placement of the shape transfer mold M on the jig 110. Similarly, in the situation where the front end (moving end) of the first robot arm 120 moves to the storage place P1, the first universal holding part 122 maintaining the conformed shape easily holds (adsorbs and fixes) the item W locally in a corresponding manner through the first adsorption components 122a in a state where the item W does not deform. Thereafter, the first robot arm 120 places the held item W on the jig 110 through movement, and the first robot arm 120 releases the holding (releases adsorption), thereby completing the placement of the item W on the jig 110. However, the disclosure does not limit the specific structure and action of the first robot arm 120, which may be adjusted according to requirements.

Furthermore, in the present embodiment, as shown in FIG. 4, the second universal holding part 132 of the second robot arm 130 includes a plurality of second adsorption components 132a (for example, three) formed by suction cups and a vacuum source (not shown), and multiple second drive pins 132b that are movable. In the situation where the front end (moving end) of the second robot arm 130 disposed with the second universal holding part 132 moves to the jig 110, the second universal holding part 132 abuts the shape transfer mold M through the second drive pins 132b to conform the shape of the shape transfer mold M (corresponding to the shape of the item W) and maintains the conformed shape (for example, locking the second drive pins 132b), and holds (adsorbs and fixes) the shape transfer mold M through the second adsorption components 132a. Here, the conformation of the shape of the shape transfer mold M refers to making the front ends of the second drive pins 132b abut the surface of the shape transfer mold M respectively through the movement of the movable second universal holding part 132 or the second robot arm 130, and making the second drive pins 132b move through abutting the surface of the shape transfer mold M. Furthermore, the maintaining of the conformed shape refers to locking the second drive pins 132b that move through abutting the surface of the shape transfer mold M to fix current positions of the second drive pins 132b, positioning the second drive pins 132b at positions abutting the shape transfer mold M without moving due to abutting the shape transfer mold M. Thereafter, the jig 110 releases holding (releases adsorption), and the second robot arm 130 takes away the held shape transfer mold M from the jig 110 through movement, thereby completing the retrieving of the shape transfer mold M from the jig 110. Similarly, in the situation where the front end (moving end) of the second robot arm 130 moves to the jig 110, the second universal holding part 132 maintaining the conformed shape easily holds (adsorbs and fixes) the item W locally in a corresponding manner through the second adsorption components 132a in a state where the item W does not deform. Thereafter, the jig 110 releases holding (releases adsorption), and the second robot arm 130 takes away the held item W from the jig 110 through movement, thereby completing the retrieving of the item W from the jig 110. Furthermore, compared to the structure of the first universal holding part 122, the second universal holding part 132 further includes a plurality of clamping pressing components 134 (for example, three), thereby the second robot arm 130 may take away the shape transfer mold M or the item W from the jig 110 and proceed for subsequent assembly. However, the disclosure does not limit the specific structure and action of the second robot arm 130, which may be adjusted according to requirements.

Additionally, in the present embodiment, as shown in FIG. 1 and FIG. 2, the universal placement part 112 of the jig 110 includes multiple universal adsorption components 112a formed by suction cups and a vacuum source (not shown), and multiple universal drive pins 112b that are movable. Thus, as shown in FIG. 5A, the universal drive pins 112b of the universal placement part 112 are positioned at initial positions. Next, as shown in FIG. 5B, in the situation where the first robot arm 120 places the held shape transfer mold M on the jig 110, the universal placement part 112 abuts the shape transfer mold M through the universal drive pins 112b and conforms the shape of the shape transfer mold M (corresponding to the shape of the item W), placing the shape transfer mold M on the universal placement part 112. Finally, as shown in FIG. 5C, the universal drive pins 112b maintain the conformed shape (for example, locking the universal drive pins 112b that move through abutting the surface of the shape transfer mold M to fix the current positions of the universal drive pins 112b), and hold (adsorb and fix) the shape transfer mold M through the universal adsorption components 112a in a state where the shape transfer mold M does not deform. Thus, in the situation where the first robot arm 120 places the held item W on the jig 110, the universal placement part 112 maintaining the conformed shape may easily hold (adsorb and fix) the item W locally in a corresponding manner in a state where the item W does not deform. However, the disclosure does not limit the specific structure and action of the jig 110, which may be adjusted according to requirements.

Through the above configuration, in the item transport device 100 of the present embodiment, the first robot arm 120 conforms the shape of the item W through the first universal holding part 122 abutting the shape transfer mold M corresponding to the shape of the item W, the second robot arm 130 conforms the shape of the item W through the second universal holding part 132 abutting the shape transfer mold M, and the jig 110 conforms the shape of the item W through the universal placement part 112 abutting the shape transfer mold M. Moreover, the first robot arm 120 places the item W on the universal placement part 112 based on the position coordinates that have conformed the shape transfer mold M on the jig 110, and the second robot arm 130 retrieves the item W from the universal placement part 112. In this way, without being limited by the type of the item W, the item transport device 100 may conform the shape of the item W through the universal equipment such as the first robot arm 120, the second robot arm 130, and the jig 110 in combination with the shape transfer mold M corresponding to the shape of the item W. In particular, the shape of the item W may be transferred to the first universal holding part 122, the second universal holding part 132, and the universal placement part 112 through the shape transfer mold M, thereby enabling positioning to the required degree for transport and transporting the item W with a simplified structure such as transport of the shape transfer mold without requiring precise positioning means (for example, omitting positioning means or detection means in the related art). Accordingly, the item transport device 100 may improve item transport efficiency through simple component composition and have versatility. However, the item transport device 100 is not limited to merely mounting the first robot arm 120 for placement and the second robot arm 130 for retrieving. In other embodiments not shown, a third robot arm dedicated to placing the shape transfer mold M may be additionally mounted, or the shape transfer mold M may be placed manually, with the first robot arm 120 merely configured to place the item W. The disclosure does not limit the specific structure and action of the item transport device 100, which may be adjusted according to requirements.

More specifically, as shown in FIG. 1, FIG. 2, and FIG. 6, in the present embodiment, the item transport device 100 further includes a control component 140. The control component 140 controls the actions of the first robot arm 120 and the second robot arm 130. The control component 140 is, for example, a control unit or a processing unit electrically connected to the first robot arm 120 and the second robot arm 130, thereby controlling the first robot arm 120 and the second robot arm 130 according to preset actions, in which the control component 140 controls the first robot arm 120 and the second robot arm 130 to perform the following actions. The first robot arm 120 retrieves the shape transfer mold M from the mold placement place P2 and places on the jig 110 (action 1), and the second robot arm 130 retrieves the shape transfer mold M from the jig 110 and places at the mold placement place P2 (action 2). Thereafter, the control component 140 controls the first robot arm 120 and the second robot arm 130 to perform the following actions. The first robot arm 120 retrieves the item W from the storage place P1, and based on the position of the universal placement part 112 where the shape transfer mold M is placed on the jig 110 (position coordinates that have conformed the shape), places the item W on the universal placement part 112 of position coordinates that have conformed the shape transfer mold M on the jig 110 (action 3), and the second robot arm 130 retrieves the item W from the universal placement part 112 on the jig 110 based on the position of the universal placement part 112 where the shape transfer mold M is retrieved from the jig 110 (position coordinates that have conformed the shape) (action 4). As an example, as long as the movement of the first robot arm 120 and the second robot arm 130 near the jig 110 does not interfere with each other, the action 2 of the second robot arm 130 and the action 3 of the first robot arm 120 may be performed in parallel (almost simultaneously), thereby improving item transport efficiency, but the actions 1 to 4 may also be completed sequentially, and the disclosure is not limited thereto.

From the above, it may be understood that in the item transport device 100 of the present embodiment, the action 1 to the action 4 of the first robot arm 120 and the second robot arm 130 may be controlled through the control component 140, in which through the actions of placing the shape transfer mold M on the jig 110 and retrieving from the jig 110 using the first robot arm 120 and the second robot arm 130 (the action 1 and the action 2), the first robot arm 120 and the second robot arm 130 configured to hold the shape transfer mold M and the jig 110 configured to place the shape transfer mold M may conform the shape of the shape transfer mold M (corresponding to the shape of the item W) through the first universal holding part 122, the second universal holding part 132, and the universal placement part 112. Subsequently, in the process of transporting the item W, the first robot arm 120 and the second robot arm 130 may hold the item W in a state where the item W does not deform through the first universal holding part 122 and the second universal holding part 132 that maintain the conformed shape, and place the item W on the jig 110 or retrieve from the jig 110 based on the position where the shape transfer mold M is placed and retrieved on the jig 110 (position coordinates that have conformed the shape) (the action 3 and the action 4). In this way, the item transport device 100 may obtain position coordinates corresponding to the shape of the item W as the control condition required for subsequent transport of the item W through the operation of the first robot arm 120, the second robot arm 130, and the jig 110 in combination with the shape transfer mold M (that is, obtain the position coordinates required for the action 3 and the action 4 as the control condition through the action 1 and the action 2), thereby eliminating the need for additional positioning means or detection means to perform positioning to the degree required for transport and transport of the item W. Moreover, the action 1 and the action 3 of the first robot arm 120 and the action 2 and the action 4 of the second robot arm 130 proceed alternately, enabling more efficient transport of the item W. However, the disclosure does not limit the specific structure of the control component 140 and the control actions for the first robot arm 120, the second robot arm 130, and the jig 110, for example, which may be adjusted according to requirements.

Furthermore, in the present embodiment, as shown in FIG. 1, FIG. 2, and FIG. 7, the item transport device 100 may transport the same type of item W (for example, fender, front vehicle door, or rear vehicle door) multiple times. For example, the control component 140 controls the first robot arm 120 and the second robot arm 130 to perform the action 1 to the action 4, transporting one item W to the installation place P3 and performing assembly (for example, assembling to a vehicle frame). Subsequently, the assembled vehicle body structure moves to a next location through an unillustrated transport device (such as a conveyor belt) on the production line, and a next unassembled vehicle body structure moves to the installation place P3 through the aforementioned transport device. Subsequently, the item transport device 100 again performs transport of the next item W. From the above, it may be understood that transporting one item W through the action 1 to the action 4 is called one cycle, and the item transport device 100 performs multiple cycles to transport the same type of item W. Thus, the item transport device 100 may be applied in production lines to repeatedly transport the same type of item W multiple times, making the transport of item W systematic and continuous. As an example, as long as the movement of the first robot arm 120 and the second robot arm 130 near the jig 110 does not interfere with each other, during the process where the control component 140 controls the second robot arm 130 to perform the action 4, the control component 140 controls the first robot arm 120 to perform the next action 1. That is to say, the timing of two consecutive cycles partially overlaps, which may shorten the time required for continuous multiple transports of the item W, thereby improving item transport efficiency. However, the actions 1 to 4 of multiple cycles may also be completed sequentially, and the disclosure is not limited thereto.

Furthermore, in the present embodiment, as shown in FIG. 1, FIG. 2 and FIG. 8, the item transport device 100 may transport multiple items W of different types (for example, fenders, front vehicle doors, or rear vehicle doors). Specifically, the items W include multiple items W of different types that constitute one finished product C (for example, a vehicle body structure), and the multiple items W include, for example, at least a first item W1 and a second item W2 of different types that constitute one finished product C. The shape transfer mold M includes multiple shape transfer molds M respectively corresponding to the items W of different types, and the multiple shape transfer molds M include, for example, at least a first shape transfer mold M1 corresponding to the first item W1 and a second shape transfer mold M2 corresponding to the second item W2. The first robot arm 120 and the second robot arm 130 sequentially transport the multiple items W of different types for the finished product C. That is, transporting one item W through the action 1 to the action 4 is called one cycle, and the item transport device 100 performs multiple cycles to sequentially transport the first item W1 and the second item W2 of different types to assemble the items into the finished product C. For example, the control component 140 controls the first robot arm 120 and the second robot arm 130 to perform the action 1 to the action 4 to transport one item W (for example, the first item W1) to the installation place P3 and perform assembly. Subsequently, the control component 140 controls the first robot arm 120 and the second robot arm 130 to perform the action 1 to the action 4 to transport another item W (for example, the second item W2) to the installation place P3 and perform assembly. The assembled finished product C moves to a next location through an unillustrated transport device (such as a conveyor belt) on the production line, and a next unassembled vehicle body structure moves to the installation place P3 through the aforementioned transport device. Subsequently, the item transport device 100 again performs the next round of transport of multiple items W of different types, thereby performing multiple cycles to transport multiple items W of different types.

More specifically, in the present embodiment, as shown in FIG. 1, FIG. 2, and FIG. 8, the control component 140 controls the first robot arm 120 and the second robot arm 130 to perform the following actions. The first robot arm 120 retrieves the first shape transfer mold M1 from the mold placement place P2 and places on the jig 110 (action 1), thereby conforming the shape through the first shape transfer mold M1, and the second robot arm 130 retrieves the first shape transfer mold M1 from the jig 110 (action 2), thereby conforming the shape through the first shape transfer mold M1. Subsequently, the first robot arm 120 retrieves the first item W1 from the storage place P1 and places on the jig 110 (action 3), and the second robot arm 130 retrieves the first item W1 from the jig 110 (action 4). Subsequently, the universal placement part 112 of the jig 110 that conforms the shape of the first shape transfer mold M1 moves to the initial position through spring reaction force or actuator drive (but the disclosure is not limited thereto). Subsequently, the control component 140 controls the first robot arm 120 and the second robot arm 130 to perform the following actions. The first robot arm 120 retrieves the second shape transfer mold M2 from the mold placement place P2 and places on the jig 110 (action 1), thereby conforming the shape through the second shape transfer mold M2, and the second robot arm 130 retrieves the second shape transfer mold M2 from the jig 110 (action 2), thereby conforming the shape through the second shape transfer mold M2. Subsequently, the first robot arm 120 retrieves the second item W2 from the storage place P1 and places on the jig 110 (action 3), and the second robot arm 130 retrieves the second item W2 from the jig 110 (action 4). In this way, the item transport device 100 may be applied in production lines to repeatedly transport items W of different types multiple times (such as the first item W1 and the second item W2), making the transport of items W systematic and continuous. Moreover, multiple items W of different types conform shapes through corresponding multiple shape transfer molds M, thereby enabling the item transport device 100 to transport the items W in a manner that most conforms to the shape of the currently transported item W, and to proceed with the transport of multiple items W of different types using the same operations of action 1 to action 4, thereby improving the versatility of the item transport device 100.

Furthermore, in the present embodiment, as shown in FIG. 1, FIG. 2, and FIG. 8, the control component 140 performs a Nth cycle of transporting a set of the first item W1 and the second item W2 corresponding to one finished product C (for example, a vehicle body structure), and after completing the Nth cycle, perform a (N+1)th cycle of transporting a next set of the first item W1 and the second item W2 corresponding to a next finished product C, where N is a natural number greater than 0 (such as 1, 2, 3). The upper limit of the number of cycles may be adjusted according to requirements. That is to say, the item transport device 100 sequentially transports one each of multiple items W of different types to complete one finished product C, in which after the item transport device 100 completes the Nth cycle corresponding to the Nth finished product C (for example, the first vehicle) and transports a set of first item W1 and second item W2 (multiple items W) of different types, the device performs the (N+1)th cycle corresponding to the (N+1)th finished product C (for example, the second vehicle) and transports a set of first item W1 and second item W2 (multiple items W) of different types. In this way, the item transport device 100 may be applied in production lines to repeatedly transport items W of different types multiple times (such as first item W1 and second item W2), making the transport of items W systematic and continuous. Moreover, without the need to switch the operation modes of the first robot arm 120, the second robot arm 130, and the jig 110, by adopting the same operations of action 1 to action 4 to transport multiple items W of different types, the versatility of the item transport device 100 may be improved, and finished products C (for example, vehicle body structures) formed by multiple items W may be easily manufactured without significantly modifying equipment on the production line (for example, omitting mechanical learning of robot arms). However, the disclosure is not limited thereto and may be adjusted according to requirements.

As an example, in this embodiment, as shown in FIG. 1, FIG. 2, and FIG. 8, as long as the movement of the first robot arm 120 and the second robot arm 130 near the jig 110 does not interfere with each other, during the process in which the control component 140 controls the second robot arm 130 to perform one of the actions 4, the control component 140 may also control the first robot arm 120 to perform the next action 1. For example, the control component 140 controls the first robot arm 120 and the second robot arm 130 to perform the following actions. During the process in which the second robot arm 130 retrieves the first item W1 from the jig 110 (action 4), the first robot arm 120 also retrieves the second shape transfer mold M2 from the mold placement place P2 and places on the jig 110 (action 1). Similarly, during the process in which the control component 140 controls the second robot arm 130 to perform the action 4 of the Nth cycle, the control component 140 may also control the first robot arm 120 to perform the action 1 of the (N+1)th cycle. For example, the control component 140 controls the first robot arm 120 and the second robot arm 130 to perform the following actions. During the process in which the second robot arm 130 retrieves the second item W2 from the jig 110 (action 4) in the Nth cycle, the first robot arm 120 retrieves the first shape transfer mold M1 from the mold placement place P2 and places on the jig 110 (action 1) in the (N+1)th cycle. In this way, without being limited by the type of item W, the timing of two consecutive cycles partially overlaps, which may shorten the time required for continuous multiple transports of the items W of different types, thereby improving item transport efficiency. However, the actions 1 to 4 of multiple cycles may also be completed sequentially, and the disclosure is not limited thereto.

Additionally, in the present embodiment, as shown in FIG. 1, the item transport device 100 further includes a scanning component 150. The scanning component 150 is disposed on at least one of the first robot arm 120 and the second robot arm 130, and is configured to detect the shape of the item W or the shape transfer mold M (in FIG. 1, for example, a scanning component 150a is disposed on the first robot arm 120 and a scanning component 150b is disposed on the second robot arm 130). Thus, during the process of performing the action 1 to the action 4, it is possible to obtain any position of the item W or the shape transfer mold M (for example, the shape of the outer end portion) or the approximate position of the jig 110 through the scanning component 150a and/or the scanning component 150b, therefore it is possible to place the item W or the shape transfer mold M in an area that does not protrude from the jig 110 and improve the accuracy of transporting the item W. Furthermore, the scanning component 150 may also scan merely the shape transfer mold M without scanning the item W. If the position coordinates of the shape transfer mold M may be obtained, the position coordinates of the item W may be shared through repeated actions, and the time for the first robot arm 120 to place the item W on the jig 110 and the time for the second robot arm 130 to retrieve the item W from the jig 110 can be further reduced by omitting the time for scanning the item W, thereby saving the item transport time before the second robot arm 130 proceeds to the next process (for example, perform assembly at the installation place P3 of the production line). However, the disclosure does not limit the disposition position of the scanning component 150, the scanning action, and whether it is disposed or not, which may be adjusted according to requirements.

Similarly, in the present embodiment, as shown in FIG. 1, the item transport device 100 further includes a scanning component 160. The scanning component 160 is disposed on the jig 110 and is configured to detect the shape of the universal placement part 112. As an example, the scanning component 160 configured to detect the shape of the universal placement part 112 preferably uses a scanner such as a camera or sensor that performs three-dimensional imaging of objects, for example, a 3D vision sensor. Moreover, the scanning component 160 determines the type of the item W by detecting the height of the universal drive pins 112b that abut and retract with the item W placed on the universal placement part 112. Thus, in the process where the jig 110 conforms the shape of the shape transfer mold M (corresponding to the shape of the item W) through the universal placement part 112, it may be obtained through the scanning component 160 which item W the universal placement part 112 currently has a shape corresponding to, thereby enabling combination of the position coordinates held by the first robot arm 120 and the second robot arm 130 and improving the accuracy of transporting the item W. However, the disclosure does not limit the disposition position of the scanning component 160, the scanning action, and whether it is disposed or not, which may be adjusted according to requirements.

Furthermore, in the present embodiment, as shown in FIG. 1 and FIG. 9, the shape transfer mold M includes a surface transfer face S1 corresponding to a surface of the item W, and an inner transfer surface S2 corresponding to an inner side of the item W, and is integrally formed through a thick section T of a preset thickness between the surface transfer face S1 and the inner transfer surface S2. As an example, the shape transfer mold M is manufactured by, for example, connecting two items W (for example, two fenders) integrally through the thick section T having a preset thickness in the placement direction (vertical direction). Therefore, compared to the conventional technology of manufacturing shape transfer molds through jig molds, it is possible to more easily manufacture a shape transfer mold M having a surface transfer face S1 (provided by the surface of the upper item W) and an inner transfer surface S2 (provided by the inner side of the lower item W). Moreover, in the situation where the item W is a flexible component formed by resin molding, if merely one or multiple items W are used as the shape transfer mold M, the shape transfer mold M (still being a flexible component) may deform due to the reaction force from the universal drive pins 112b of the universal placement part 112 when placed on the jig 110, making it difficult for the jig 110 to conform the correct shape of the shape transfer mold M. Therefore, by manufacturing the shape transfer mold M in the above manner (having the thick section T of preset thickness), it is possible to impart rigidity to the shape transfer mold M so that it does not easily deform. Additionally, by manufacturing the shape transfer mold M in the above manner, height position coordinates of the shape transfer mold M in the placement direction (vertical direction) differ from height position coordinates of the item W by a height amount of the thick section T. In this situation, it may also be possible to further correct the position coordinates of the item W and the shape transfer mold M for the first robot arm 120 and the second robot arm 130. However, the disclosure is not limited thereto and may be adjusted according to requirements.

After explaining the relevant content of the item transport device 100 of the present embodiment, an item transport method of the present embodiment will be described below together with FIG. 1, FIG. 2, and FIG. 10.

Referring to FIG. 1, FIG. 2, and FIG. 10, in this embodiment, the item transport method transports the item W through the item transport device 100. The item transport device 100 includes a jig 110, a first robot arm 120, a second robot arm 130, and a control component 140. The jig 110 is configured to place the item W to be transported (for example, vehicle body parts such as fenders, front vehicle doors, or rear vehicle doors used for being assembled into a vehicle body structure, but the disclosure is not limited thereto). The first robot arm 120 retrieves item W from the storage place P1 and places on the jig 110. The second robot arm 130 retrieves the item W placed on the jig 110. The control component 140 controls the actions of the first robot arm 120 and the second robot arm 130. The first robot arm 120 has a first universal holding part 122, the first universal holding part 122 conforms the shape of the item W through abutting the shape transfer mold M and maintains the conformed shape, and the shape transfer mold M has a shape corresponding to the item W. The second robot arm 130 has a second universal holding part 132, the second universal holding part 132 conforms the shape of the item W by contacting with shape transfer mold M and maintains the conformed shape. The jig 110 has a universal placement part 112, the universal placement part 112 conforms the shape of item W through abutting the shape transfer mold M and maintains the conformed shape. Regarding the structural composition of the jig 110, the first robot arm 120, the second robot arm 130, and the control component 140, reference may be made to the aforementioned description, so details will not be repeated here.

Furthermore, in the present embodiment, as shown in FIG. 10, the item transport method controls the first robot arm 120 and the second robot arm 130 through the control component 140 to perform the following actions. In action 1, the first robot arm 120 retrieves the shape transfer mold M from the mold placement place P2 and places on the jig 110, and in the action 2, the second robot arm 130 retrieves the shape transfer mold M from the jig 110 and places at the mold placement place P2. Thereafter, the control component 140 controls the first robot arm 120 and the second robot arm 130 to perform the following actions. In action 3, the first robot arm 120 retrieves the item W from the storage place P1, and based on the position of the universal placement part 112 where the shape transfer mold M is placed on the jig 110 (position coordinates that have conformed the shape), places the item W on the universal placement part 112 of position coordinates that have conformed the shape transfer mold M on the jig 110, and in action 4, the second robot arm 130 retrieves the item W from the universal placement part 112 on the jig 110 based on the position of the universal placement part 112 where the shape transfer mold M is retrieved from the jig 110 (position coordinates that have conformed the shape). As an example, as long as the movement of the first robot arm 120 and the second robot arm 130 near the jig 110 does not interfere with each other, the action 2 of the second robot arm 130 and the action 3 of the first robot arm 120 may be performed in parallel (almost simultaneously), thereby improving item transport efficiency, but the action 1 to the action 4 may also be completed sequentially, and the disclosure is not limited thereto. Furthermore, in situations where multiple items W of the same type are transported through the item transport device 100 (as shown in FIG. 7), or multiple items W (for example, first item W1, second item W2) of different types are transported (as shown in FIG. 8), the item transport method may execute the actions 1 to 4 multiple times to perform multiple transports. Regarding the process of transporting items W multiple times, reference may be made to the aforementioned description, so details will not be repeated here.

Through the above configuration, in the item transport method of the present embodiment (transporting the item W by executing the action 1 to the action 4 through the item transport device 100), the first robot arm 120 conforms the shape of the item W through the first universal holding part 122 abutting the shape transfer mold M corresponding to the shape of the item W, the second robot arm 130 conforms the shape of the item W through the second universal holding part 132 abutting the shape transfer mold M, and the jig 110 conforms the shape of the item W through the universal placement part 112 abutting the shape transfer mold M. Moreover, the first robot arm 120 places the item W on the universal placement part 112 based on the position coordinates that have conformed the shape transfer mold M on the jig 110, and the second robot arm 130 retrieves the item W from the universal placement part 112. In this way, without being limited by the type of the item W, the item transport method may conform the shape of the item W through the universal equipment such as the first robot arm 120, the second robot arm 130, and the jig 110 of the item transport device 100 in combination with the shape transfer mold M corresponding to the shape of the item W. In particular, the shape of the item W may be transferred to the first universal holding part 122, the second universal holding part 132, and the universal placement part 112 through the shape transfer mold M, thereby enabling positioning to the required degree for transport and transporting the item W with a simplified structure such as transport of the shape transfer mold without requiring precise positioning means (for example, omitting positioning means or detection means in the related art). Accordingly, the item transport method may improve item transport efficiency through simple component composition and have versatility. However, the disclosure does not limit the process steps of the item transport method, which may be adjusted according to requirements.

Additionally, in the present embodiment, as shown in FIG. 1 and FIG. 10, the item transport device 100 further includes a scanning component 150. The scanning component 150 is disposed on at least one of the first robot arm 120 and the second robot arm 130, and is configured to detect the shape of the item W or the shape transfer mold M (in FIG. 1, for example, a scanning component 150a is disposed on the first robot arm 120 and a scanning component 150b is disposed on the second robot arm 130). Regarding the disposition position of the scanning component 150, reference may be made to the aforementioned description, so details will not be repeated here. Therefore, in the item transport method, for example, the control component 140 controls the scanning component 150 to perform the following actions. When the first robot arm 120 retrieves the shape transfer mold M from the mold placement place P2 and places on the jig 110 (action 1), the scanning component 150 scans the shape transfer mold M and sends position coordinates to the control component 140, and when the second robot arm 130 retrieves the shape transfer mold M from the jig 110 and places at the mold placement place P2 (action 2), the scanning component 150 scans the shape transfer mold M and sends position coordinates to the control component 140. Subsequently, when the first robot arm 120 places the item W on the jig 110 based on the position of the universal placement part 112 where the shape transfer mold M is placed on the jig 110 (position coordinates that have conformed the shape) (action 3), the scanning component 150 scans the item W when the first robot arm 120 retrieves the item W from the storage place P1 and sends position coordinates to the control component 140, and when the second robot arm 130 retrieves the item W from the jig 110 based on the position of the universal placement part 112 where the shape transfer mold M is retrieved from the jig 110 (position coordinates that have conformed the shape) (action 4), while transporting the item W on the jig 110, the scanning component 150 does not perform scanning on the item W. Furthermore, when executing the action 3, the scanning component 150 may also perform the following action. When the first robot arm 120 places the item W on the jig 110 based on the position of the universal placement part 112 where the shape transfer mold M is placed on the jig 110 (position coordinates that have conformed the shape), the scanning component 150 does not perform scanning on the item W when the first robot arm 120 retrieves the item W from the storage place P1.

From the above, it may be understood that in the item transport method of the present embodiment, during the process of performing the action 1 to action 4, arbitrary positions (for example, the shape of the outer end portion) of the shape transfer mold M may be obtained through the scanning component 150a and/or the scanning component 150b and position coordinates may be sent to the control component 140, therefore it is possible to place the shape transfer mold M in an area that does not protrude from the jig 110 and improve the accuracy of subsequent transport of the item W. Furthermore, when the position of the item W cannot be obtained from the storage place P1 during execution of the action 3 (for example, in the situation where the item W is disposed in a device having multiple layers in the longitudinal direction), the scanning component 150 scans the item W and sends position coordinates to the control component 140, therefore the first robot arm 120 may obtain the position of the item W, and the item W may be retrieved through control by the control components 140. In contrast, when the position of the item W may be obtained from the storage place P1 during execution of the action 3 (for example, in the situation where the item W is disposed in a device having a single layer in the longitudinal direction and the position of the item W may be obtained in advance), even if the scanning component 150 does not perform scanning on the item W, the first robot arm 120 may still obtain the position of the item W, therefore scanning of the item W is omitted for simplification of steps. Similarly, during execution of the action 4, the position of the item W on the jig 110 is already determined, even if the scanning component 150 does not perform scanning on the item W, the second robot arm 130 may still obtain the position of the item W, therefore scanning of the item W is omitted for simplification of steps. If the position coordinates of the shape transfer mold M may be obtained, the position coordinates of the item W may be shared through repeated actions, and furthermore, the time for the first robot arm 120 to place the item W on the jig 110 and the time for the second robot arm 130 to retrieve the item W from the jig 110 may be reduced by omitting the time for scanning the item W, thereby saving the item transport time before the second robot arm 130 proceeds to a next process (for example, performing assembly at the installation place P3 of the production line). However, the disclosure does not limit whether the item transport method uses the scanning component 150 of the item transport device 100 to detect the shape of the item W or the shape transfer mold M, which may be adjusted according to requirements.

In summary, in the item transport device and the item transport method of the disclosure, the first robot arm conforms the shape of the item through the first universal holding part abutting the shape transfer mold corresponding to the shape of the item, the second robot arm conforms the shape of the item through the second universal holding part abutting the shape transfer mold, and the jig conforms the shape of the item through the universal placement part abutting the shape transfer mold. Moreover, the first robot arm places the item on the universal placement part based on the position coordinates that have conformed the shape transfer mold on the jig, and the second robot arm retrieves the item from the universal placement part. In this way, without being limited by the type of the item, the item transport device and the item transport method may conform the shape of the item through the universal equipment such as the first robot arm, the second robot arm, and the jig in combination with the shape transfer mold corresponding to the shape of the item, thereby enabling positioning to the required degree for transport and transporting the item with a simplified structure such as transport of the shape transfer mold without requiring precise positioning means (for example, omitting positioning means or detection means in the related art). Preferably, the item transport device further includes a control component that control the actions of the first robot arm and the second robot arm, thereby enabling easy control of the first robot arm and the second robot arm to perform the action 1 to action 4. Accordingly, the item transport device and the item transport method of the disclosure may improve item transport efficiency through simple component composition and have versatility.

Finally, it should be noted that the foregoing embodiments are merely used to illustrate the technical solutions of the disclosure, and the embodiments are not intended to limit the disclosure. Although the disclosure has been described in detail with reference to the embodiments, persons of ordinary skill in the art should understand that they may still modify the technical solutions described in the embodiments, or make equivalent substitutions for some or all of the technical features thereof; and the modifications or substitutions do not cause the essence of the corresponding technical solutions to depart from the scope of the technical solutions of the embodiments of the disclosure.

What is claimed is:

1. An item transport device, comprising:
a jig configured to place an item to be transported;
a first robot arm retrieving the item from a storage place and placing on the jig; and
a second robot arm retrieving the item placed on the jig, wherein the first robot arm has a first universal holding part, the first universal holding part conforms a shape of the item through abutting a shape transfer mold and maintains the conformed shape, and the shape transfer mold has a shape corresponding to the item,
the second robot arm has a second universal holding part, the second universal holding part conforms the shape of the item through abutting the shape transfer mold and maintains the conformed shape,
the jig has a universal placement part, the universal placement part conforms the shape of the item through abutting the shape transfer mold and maintains the conformed shape,
the first robot arm places the item on the universal placement part of position coordinates that have conformed the shape transfer mold on the jig, and
the second robot arm retrieves the item from the universal placement part on the jig.

2. The item transport device according to claim 1, further comprising:
a control component controlling actions of the first robot arm and the second robot arm, wherein
the control component controls the first robot arm and the second robot arm to perform actions as follows:
the first robot arm retrieves the shape transfer mold from the mold placement place and places on the jig, and
the second robot arm retrieves the shape transfer mold from the jig and places at the mold placement place.

3. The item transport device according to claim 2, wherein
the control component controls the first robot arm and the second robot arm to perform actions as follows:
the first robot arm places the item on the jig based on a position of the universal placement part where the shape transfer mold is placed on the jig, and
the second robot arm retrieves the item from the jig based on the position of the universal placement part where the shape transfer mold is retrieved from the jig.

4. The item transport device according to claim 1, wherein
the item comprises a plurality of items of different types that constitute one finished product,
the shape transfer mold comprises a plurality of shape transfer molds respectively corresponding to the items of different types, and
the first robot arm and the second robot arm sequentially transport the items of different types for the finished product.

5. The item transport device according to claim 4, further comprising:
a control component controlling actions of the first robot arm and the second robot arm, wherein
the items at least comprise a first item and a second item that are of different types and constitute the one finished product,
the shape transfer molds comprise at least a first shape transfer mold corresponding to the first item and a second shape transfer mold corresponding to the second item, and
the control component controls the first robot arm and the second robot arm to perform actions as follows:
the first robot arm retrieves the first shape transfer mold from the mold placement place and places on the jig,
the second robot arm retrieves the first item from the jig,
the first robot arm retrieves the second shape transfer mold from the mold placement place and places on the jig, and
the second robot arm retrieves the second item from the jig.

6. The item transport device according to claim 5, wherein
the control component controls the first robot arm and the second robot arm to perform actions as follows:
in a process of the second robot arm retrieving the first item from the jig, the first robot arm retrieves the second shape transfer mold from the mold placement place and places on the jig.

7. The item transport device according to claim 5, wherein
the control component performs a Nth cycle of transporting a set of the first item and the second item corresponding to the one finished product, and after completing the Nth cycle, perform a (N+1)th cycle of transporting a next set of the first item and the second item corresponding to a next one of the finished product, where N is a natural number greater than 0.

8. The item transport device according to claim 7, wherein
the control component controls the first robot arm and the second robot arm to perform actions as follows:
in a process of the second robot arm retrieving the second item from the jig in the Nth cycle, the first robot arm retrieves the first shape transfer mold from the mold placement place and places on the jig in the (N+1)th cycle.

9. The item transport device according to claim 1, further comprising:
a scanning component disposed on at least one of the first robot arm and the second robot arm, and configured to detect the shape of the item or the shape transfer mold.

10. The item transport device according to claim 1, further comprising:
a scanning component disposed on the jig, and configured to detect a shape of the universal placement part.

11. The item transport device according to claim 1, wherein
the shape transfer mold comprises a surface transfer face corresponding to a surface of the item, and an inner transfer surface corresponding to an inner side of the item, and is integrally formed with a thick section of a preset thickness between the surface transfer face and the inner transfer surface.

12. An item transport method transporting an item through an item transport device, wherein the item transport device comprises:
a jig configured to place an item to be transported;
a first robot arm retrieving the item from a storage place and placing on the jig;
a second robot arm retrieving the item placed on the jig; and
a control component controlling actions of the first robot arm and the second robot arm, wherein
the first robot arm has a first universal holding part, the first universal holding part conforms a shape of the item through abutting the shape transfer mold and maintains the conformed shape, and the shape transfer mold has a shape corresponding to the item,
the second robot arm has a second universal holding part, the second universal holding part conforms the shape of the item through abutting the shape transfer mold and maintains the conformed shape,
the jig has a universal placement part, the universal placement part conforms the shape of the item through abutting the shape transfer mold and maintains the conformed shape,
the item transport method comprises controlling, by the control component, the first robot arm and the second robot arm to perform actions as follows:
the first robot arm retrieves the shape transfer mold from the mold placement place and places on the jig,
the second robot arm retrieves the shape transfer mold from the jig and places at the mold placement place,
the first robot arm places the item on the jig based on a position of the universal placement part where the shape transfer mold is placed on the jig, and
the second robot arm retrieves the item from the jig based on the position of the universal placement part where the shape transfer mold is retrieved from the jig.

13. The item transport method according to claim 12, wherein
the item transport device further comprises a scanning component disposed on at least one of the first robot arm and the second robot arm, and configured to detect a shape of the item or the shape transfer mold, and
the scanning component performs actions as follows:
in response to the first robot arm retrieving the shape transfer mold from the mold placement place and places on the jig, the scanning component scans the shape transfer mold and sends position coordinates to the control component,
in response to the second robot arm retrieving the shape transfer mold from the jig and places at the mold placement place, the scanning component scans the shape transfer mold and sends position coordinates to the control component,
in response to the first robot arm placing the item on the jig based on the position of the universal placement part where the shape transfer mold is placed on the jig, the scanning component scans the item when the first robot arm retrieves the item from the storage place and sends position coordinates to the control component, and
in response to the second robot arm retrieving the item from the jig based on the position of the universal placement part where the shape transfer mold is retrieved from the jig, while transporting the item on the jig, the scanning component does not perform scanning on the item.

14. The item transport method according to claim 13, wherein
the scanning component performs actions as follows:
in response to the first robot arm placing the item on the jig based on the position of the universal placement part where the shape transfer mold is placed on the jig, the scanning component does not perform scanning on the item when the first robot arm retrieves the item from the storage place.
